(19) United States
(12) Patent Application Publication
(10) Pub. No.: US 2011/0170051 A1
(43) Pub. Date: Jul. 14, 2011

(54) HINGELESS FLEXIBLE SPECTACLE ARM

(75) Inventor: Didier Jacquemin, La Mouille (FR)

(73) Assignee: LOGO SA, Morez (FR)

(21) Appl. No.: 13/120,167

(22) PCT Filed: May 20, 2009
(86) PCT No.: PCT/FR09/50946

§ 371 Date: Mar. 22, 2011

(30) Foreign Application Priority Data
Sep. 26, 2008 (FR) 0856487

(51) Int. Cl. G02C 5/16

(52) U.S. Cl. 351/114

(57) ABSTRACT

An elastically deformable, hingeless spectacle arm is made exclusively of composite materials which have at least one layer of a reinforcing cloth and a coating or matrix made of a thermoplastic or heat-curable material.

### BACKGROUND

This invention relates to a method for producing a hingeless, resiliently deformable eyeglass arm.

It has already been proposed to produce hingeless eyeglass arms in order to reduce the number of constituent parts, to simplify the assembly process and to limit a source of discomfort for the wearer, i.e. the unscrewing of said arms or the play thereof.

It is known, to prevent this, to produce hingeless eyeglass arms from a metal alloy core, such as shape memory alloys, for example based on nickel-titanium-copper or titanium-aluminum-vanadium, in which the metal core thus obtained is substantially cylindrical.

These materials are beneficial in the sense that they provide good flexibility and good responsiveness, enabling them to return to the initial shape after the eyeglasses have been worn or after they have been folded for a long time. The arms thus obtained are generally coated with more or less flexible plastic materials, so as to enhance comfort, at least in the sheathed portion that comes into contact with the wearer's ear.

A disadvantage of this embodiment of a hingeless flexible arm lies in the number of steps necessary to produce it. It is necessary, when starting with an alloy thread, to perform wire drawing, heat treatments, welding operations, and hammering, for example, for strain hardening purposes.

Another disadvantage lies in the density of the metals and alloys used, which is greater than five. This results in relatively heavy eyeglasses, making it necessary to reduce the thickness in order to limit this problem. Consequently, there is limited freedom in the form of the arms to be produced.

### SUMMARY OF THE INVENTION

One of the objectives of this invention is to overcome these disadvantages by eliminating the metal plates in order to obtain a hingeless flexible arm.

In addition, it is generally known to use reinforcement fibers arranged in matrices, so as to coat them.

These fibers can be glass, carbon, aramide, boron, and so on. These materials have a good number of advantages, such as their lightness (density below 1.5), their excellent performance/weight ratio, their inertia with respect to environmental chemical stresses, their resistance to perspiration, their resistance to impacts, their high rigidity, the possibility of applying different types of decorations such as varnish, metal deposits, paint and pad printing, for example.

It is known to produce thermoplastic or thermosetting matrices from epoxide and modified epoxide resins, polyurethane resins, acrylic and methacrylate resins, thermosetting polyesters, urethane-acrylate resins, polyimides, polybismaleimides and polybenzimidazoles.

These fiber-filled composite materials mentioned above have already been used in the field of eyeglasses to obtain rigid faces. Of course, this application did not seek to provide flexibility of the faces.

It has also already been proposed to produce arms from composite fibers around metal cores, but these are rigid arms.

It should also be noted that the disadvantage in the use of fibers in order to obtain a composite material is the positioning thereof, which can be performed in a mold or in the form of already-impregnated parts.

In every case, it is necessary to process the parts in a second step in order to clean and trim them.

In the production of eyeglass faces, it has also been proposed to use composite materials with woven fibers.

Fiber fabrics are then positioned one on top of another, with an impregnation of the weaves, then heating in the case of thermosetting materials, or cooling in the case of thermoplastic materials.

However, again, this results in a rigid element, in this case the eyeglass face, while the desired objective is to produce a hingeless flexible arm, without any metal core made of a specific alloy.

To this end, the invention relates to a method for producing a hingeless flexible eyeglass arm, characterized in that said arm is made exclusively of composite materials, consisting of at least one layer of a reinforcement fabric and a coating or matrix made of a thermoplastic or thermosetting material.

Therefore a prejudice has clearly been overcome by the adaptation of the composite material technique, generally used to obtain rigid parts, to parts in which flexibility is desirable, such as in hingeless eyeglass arms.

Various problems in the prior art have thus been overcome, namely: the large number of steps to produce hingeless arms, while preserving responsiveness, the flexibility and initial shape of the arms in the resting position, as well as a notably reduced weight providing significant freedom in the form of the arm.

The invention also relates to the features that will be indicated in the following description, and which should be considered alone or according to all of their possible technical combinations.

### BRIEF DESCRIPTION OF THE DRAWINGS

This description, provided as a non-limiting example, will make it easier to understand how the invention can be produced in reference to the appended drawings, in which:

FIG. 1 shows, in perspective, eyeglasses equipped with flexible arms and without a hinge according to the invention.

FIG. 2 shows a top view of one of the arms according to FIG. 1, in the unfolded position.

FIG. 3 shows a front view of the arm according to FIG. 2.

FIG. 4 is a cross-section view according to line IV-IV of FIG. 2, i.e. in an extremely flexible thinned area.

FIG. 5 is a cross-section view according to line V-V of FIG. 2, in a thickened area at the user's ear, so as to ensure comfort.

FIG. 6 shows an eyeglass portion, in an exploded perspective view, and more specifically means for attaching the arm to a corresponding lens.

### DETAILED DESCRIPTION OF THE PREFERRED EMBODIMENT(S)

The eyeglasses 1 designated as a whole in FIG. 1 consist of a corrective façade, in this case two lenses 2, 3, connected to one another by a nose 4, and at their external ends, two arms 5.

According to this example embodiment, they are so-called “drilled” eyeglasses, i.e. without a frame.

The arms 5 are connected to the lenses 2, 3 without a hinge, but are resiliently deformable so as to enable them to be held by light clamping on the user's head, in the unfolded position, and to be stored in a case, for example, in the folded position.

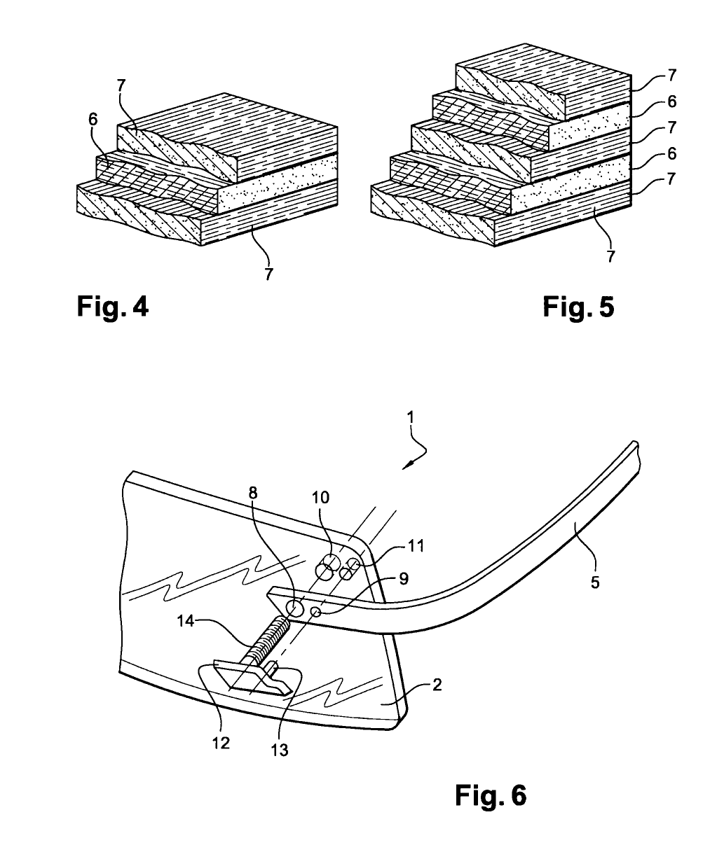

According to the invention, the arms of such eyeglasses are made exclusively of composite materials, consisting of at least one layer of a reinforcement fabric 6 and a coating 7 or matrix made of a thermoplastic or thermosetting material (see FIG. 4).

Tests have shown surprisingly that, when produced in this way, the arms are very flexible, even without a metal core for obtaining them.

FIGS. 4 and 5 show different layers mutually juxtaposed, in which each layer consists of a layer of fabrics 6 coated with a plastic matrix.

According to the desired degree of flexibility, the arm 5 consists of a plurality of reinforcement fabric layers 6 in a plastic material 7.

According to one of the possibilities, the wefts of the coated 7 fabric layers 6 are in the same longitudinal direction as the arm 5 to be obtained.

According to another possibility clearly visible in FIG. 5, the wefts of the coated 7 fabric layers 6 are arranged in different directions.

According to the desired flexibility criteria, the number of coated 7 fabric layers 6 is constant, along the arm 5, to ensure constant rigidity thereof.

According to another possibility, also clearly visible in FIG. 5, the number of coated 7 fabric layers 6 is variable along the arm 5, so as to obtain longitudinal areas of same, that are more flexible than others.

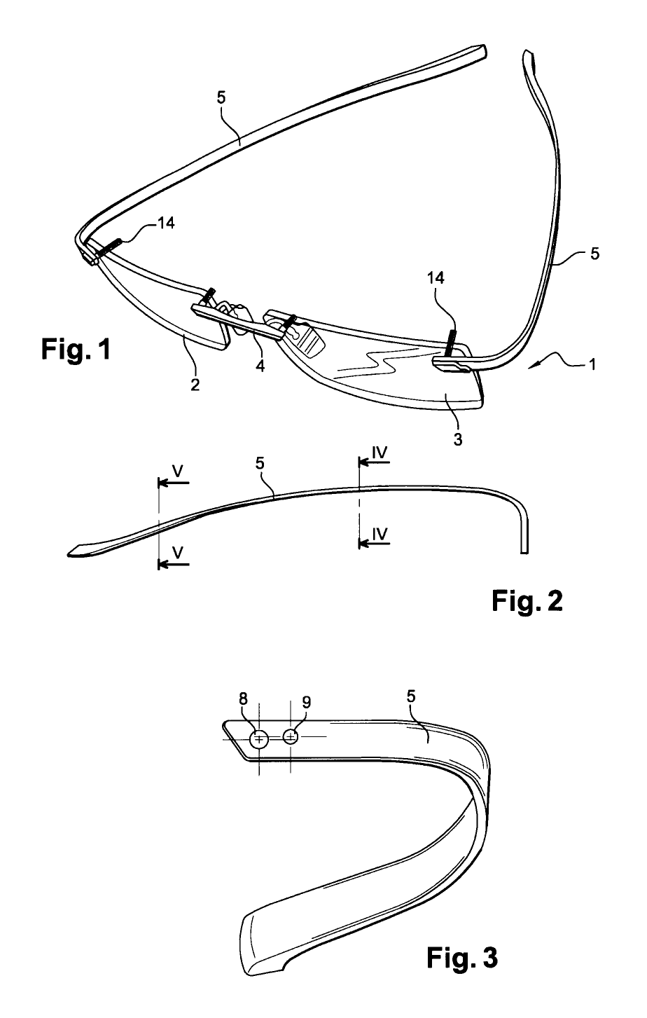

In fact, as an example, FIG. 4 shows the cross-section IV-IV the arm 5 according to FIG. 2, with an area that must be extremely flexible, and FIG. 5 shows the cross-section V-V of the same FIG. 2, for a thickened area that is intended to ensure comfort at the user's ears.

In addition, the fabrics forming the various layers 6 comprising the arm 5 are made of fibers of a predetermined thickness and type, so as to modulate the flexibility and responsiveness of said arm 5 to be obtained.

In an example embodiment, the reinforcement fabric 6 consists of carbon fibers pre-impregnated with a thermoplastic resin forming the coating 7.

According to another example embodiment, the reinforcement fabric 6 consists of glass fibers pre-impregnated with a thermosetting epoxide resin forming the coating 7.

The fibers forming the reinforcement fabric 6 may be short or continuous. Preferably, the carbon fibers will be used in areas requiring more rigidity, while the glass fibers will be preferred in areas requiring more flexibility.

Thus, according to a feature of the invention, the arm 5 is made of a combination of glass fiber fabric layers on the external layers, in order to obtain flexibility, and carbon fiber fabric layers for the central layers.

The embodiment described here consists of using carbon fiber-based reinforcement fabric pre-impregnated with an organic thermosetting resin, preferably epoxide, and positioning the assembly in a shape mold-half.

The operation is performed by positioning each additional fabric layer with a different angle, so that the wefts cross one another so as to ensure better mechanical strength in preferred directions.

Each fabric layer is cut out according to the desired shape before being positioned in the mold.

A shape mold-half with a complementary shape is then applied to the multilayer assembly, and the entirety is then heated under pressure, so as to ensure the hardening of the thermosetting resin and the cohesion of the assembly.

After cooling, the part is then removed from the mold, cleaned and trimmed. The part is then in a semi-finished state.

Of course, it is also possible to produce, by the same means, a shaped plate in which, once the assembly has been hardened, the shapes of the arms 5 are cut out, so as not to have to cut out each fabric layer according to the shape of each arm 5.

In this way, it is possible to modulate the properties of the reinforcement layers so as to obtain a combination enabling good flexibility in the direction of the opening and closing of the arms, while preserving a responsiveness and a return to the resting position, and while having deformation resistance in the direction perpendicular to the opening and closing direction.

It is also possible to vary the type of resin 7 used as a matrix. This makes it possible to very slightly modulate the flexibility, but in particular makes it possible to simplify the operations of decoration or processing of the part.

This stack makes it possible to adjust the directions of the lined fibers in the fabric so as to increase the mechanical strength in preferred directions, which was not possible in the prior art due to the presence of the metal core ensuring constant flexibility.

The orientation of the wefts significantly affects the anisotropy of the mechanical properties. It is possible to combine the orientation of various layers so as to obtain the desired results.

If the fabrics are positioned at angles of −45°/+45° with respect to the direction of the arm, it is possible to obtain a final arm that is more flexible.

If the fabrics are positioned at angles of 0°/+90° with respect to the direction of the arm, it is possible to obtain a final arm that is more rigid.

It is possible to have a series of layers with different orientations such as angles of 0°/15°/30°/45°/60°/75°/90° with respect to the direction of the arm. In this case, the rigidity of the assembly is modified so as to come close to an isotropic rigidity.

It is possible to choose the material of the matrix as a thermoplastic such as polypropylene so as to be capable of then performing an over-molding operation in order, for example, to over-mold an elastomer portion so that it comes into contact with the ear and thus ensures better strength.

As already mentioned, the matrix used here is made of a thermosetting epoxide resin, but it could be made of a thermosetting polyurethane resin, or a thermoplastic polypropylene resin, polyester, polycarbonate or any other plastic material.

This type of arm can be mounted on drilled, semi-circle or circle eyeglasses for corrective or non-corrective purposes.

The attachment of an arm as described above can be seen in FIGS. 3 and 6.

The holes 8 and 9 formed in the end of the arm 5 enable an attachment to the lens 2 or 3 which has the same holes 10, 11 owing to a small plate 12 equipped with a smooth rod 13 and a threaded rod 14.

The smooth rod 13 passes through a hole 9 of the arm 5 and a hole 11 of the lens 2 or 3, so as to ensure a first positioning.

The threaded rod 14 passes through the other hole 8 of the arm 5 and the other hole 10 of the lens 2 or 3, so as to ensure an attachment of the arm 5 on the lens 2 or 3.

The presence of these two rods makes it possible to prevent any rotation of the lens 2 or 3 with respect to the arm 5.

Of course, the invention relates not only to the method of production of the arm but to the arm itself, as well as eyeglasses with this type of arm.

1-12. (canceled)

13. A hingeless, resiliently deformable eyeglass arm, which is made exclusively of composite materials, consisting of at least one layer of a reinforcement fabric and at least one of a coating and a matrix made of at least one of a thermoplastic and thermosetting material.

14. The arm according to claim 13, wherein said arm consists of a plurality of reinforcement fabric layers and the coating.

15. The arm according to claim 14, wherein wefts of the coated fabrics are in a same longitudinal direction as said arm to be obtained.

16. The arm according to claim 14, wherein wefts of the coated fabric layers are arranged in different directions.

17. The arm according to claim 14, wherein the number of coated fabric layers is constant, along an entirety of said arm, so as to ensure constant rigidity thereof.

18. The arm according to claim 14, wherein the number of coated fabric layers is variable along said arm, so as to obtain longitudinal areas thereof that are more flexible than others.

19. The arm according to claim 14, wherein the fabrics forming the layers comprising said arm are formed by fibers of predetermined thicknesses and types, so as to modulate flexibility and responsiveness of said arm to be obtained.

20. The arm according to claim 13, wherein the reinforcement fabric consists of carbon fibers pre-impregnated with a resin forming the coating.

21. The arm according to claim 13, wherein the reinforcement fabric consists of glass fibers pre-impregnated with a resin forming the coating.

22. The arm according to claim 13, wherein the coating impregnating the reinforcement fabric is a thermoplastic resin.

23. The arm according to claim 13, wherein the coating impregnating the reinforcement fabric is a thermosetting resin.

24. The arm according to claim 20, wherein the arm is made of a combination of glass fiber fabric layers on forming external layers, to obtain flexibility, and carbon fiber fabric layers forming central layers.
